(19) United States
(12) Patent Application Publication
(10) Pub. No.: US 2026/0008966 A1
(43) Pub. Date: Jan. 8, 2026

(54) INTEGRATED CONFIGURATION UTILIZING AN ALTERNATE STRIPPING MEDIUM FOR HYDROCARBON SEPARATION

(71) Applicant: LUMMUS TECHNOLOGY LLC, Houston, TX (US)

(72) Inventors: Ujjal Mukherjee, Houston, TX (US); Derek Jones, Houston, TX (US); Pedro Santos, Houston, TX (US)

(73) Assignee: LUMMUS TECHNOLOGY LLC, Houston, TX (US)

(21) Appl. No.: 18/763,878

(22) Filed: Jul. 3, 2024

(51) Int. Cl. C10G 65/12; C01B 3/34; C10G 7/08

(52) U.S. Cl. CPC C10G 65/12; C01B 3/34; C10G 7/08; C01B 2203/065; C01B 2203/1241; C10G 2300/4037; C10G 2300/4081; C10G 2300/42

(57) ABSTRACT

A process including heating a hydrogen manufacturing unit feedstock producing a heated hydrogen manufacturing unit feedstock. The process includes stripping a wide boiling range hydrocarbon mixture with heated hydrogen manufacturing unit feedstock producing an overheads stream, separating the overheads stream to recover a non-condensed stream, and feeding the non-condensed stream to a hydrogen manufacturing unit. A process including feeding a hydrocarbon manufacturing unit feedstock to a stripping unit, recovering an overhead stream, feeding the overhead stream to a separation unit separating the hydrogen manufacturing unit feedstock from light boiling hydrocarbons, feeding a portion of the separated hydrogen manufacturing unit feedstock stream to a hydrogen manufacturing unit producing a hydrogen stream, feeding a first portion of the hydrogen stream and the bottoms stream to a first hydroprocessing unit, and feeding a second portion of the hydrogen stream, the first effluent, and the recovered medium boiling hydrocarbons to a second hydroprocessing unit.

### BACKGROUND

Refining hydrocarbon feedstocks typically includes the separation of feedstocks into different fractions based on differences in boiling points. Often, this separation requires reducing the hydrocarbon partial pressure to separate lighter molecules from heavier molecules in the feedstock. In such instances, a stripping gas including steam (or in some processes, hydrogen) is used to reduce the partial pressure of the lighter molecules, thereby separating molecules of lower boiling points from molecules of higher boiling points. However, these separation processes increase the capital cost of the overall process and lowers profitability, as the use of stripping gases is an energy intensive process.

### SUMMARY

This summary is provided to introduce a selection of concepts that are further described below in the detailed description. This summary is not intended to identify key or essential features of the claimed subject matter, nor is it intended to be used as an aid in limiting the scope of the claimed subject matter.

In one aspect, embodiments disclosed herein relate to a process for processing a wide boiling hydrocarbon mixture. A hydrogen manufacturing unit feedstock is heated to produce a heated hydrogen manufacturing unit feedstock. A wide boiling range hydrocarbon mixture is stripped with the heated hydrogen manufacturing unit feedstock to produce an overheads stream including a mixture of the hydrogen manufacturing unit feedstock, volatilized hydrocarbons, and a bottoms stream including non-volatilized hydrocarbons. The overheads stream is separated to recover a non-condensed stream including the hydrogen manufacturing unit feedstock and a condensed stream including the volatilized hydrocarbons. The non-condensed stream is fed to a hydrogen manufacturing unit.

In another aspect, embodiments disclosed herein relate to a process for producing a petrochemical feedstock from a wide boiling hydrocarbon mixture feed. A hydrogen manufacturing unit feedstock and a wide boiling hydrocarbon mixture or a portion thereof are fed to a stripping unit. An overhead stream is recovered from the stripping unit including a mixture of the hydrogen manufacturing unit feedstock, light boiling hydrocarbons of the hydrocarbon mixture, medium boiling hydrocarbons of the hydrocarbon mixture, and a bottoms stream including heavier boiling hydrocarbons of the hydrocarbon mixture. The overhead stream is fed from the stripping unit to a separation unit, where the hydrogen manufacturing unit feedstock is separated from the light boiling hydrocarbons. A portion of the separated hydrogen manufacturing unit feedstock stream is fed to a hydrogen manufacturing unit to produce a hydrogen stream. A first portion of the hydrogen stream and the bottoms stream is fed to a first hydroprocessing unit to produce a first effluent including a hydroprocessed fraction. A second portion of the hydrogen stream, the first effluent, and the recovered medium boiling hydrocarbons are fed to a second hydroprocessing unit to produce the petrochemical feedstock.

Other aspects and advantages of the claimed subject matter will be apparent from the following description and the appended claims.

### BRIEF DESCRIPTION OF DRAWINGS

FIGS. 1A-1C are simplified process flow diagrams of a stripping system in accordance with one or more embodiments.

FIG. 2 is an example of a simplified process flow diagram of a system incorporating a stripping system 1A in accordance with one or more embodiments.

FIG. 3 is an example of a simplified process flow diagram of a system incorporating a stripping system 1B in accordance with one or more embodiments.

FIG. 4 is an example of a simplified process flow diagram of a system incorporating a stripping system 1C in accordance with one or more embodiments.

### DETAILED DESCRIPTION

Traditionally, crude oil is stabilized in a petrochemical refining process by removing an ultralight cut (or “fraction”). For example, natural gas, which includes C₁, C₁-C₂ hydrocarbons, or C₁-C₃ hydrocarbons, may be vented from crude oil, thereby providing a natural gas product and a stabilized crude oil suitable for transport via pipeline. In traditional systems, the natural gas is then fed downstream for recovery via liquefaction or other means. In some instances, the natural gas is routed to one or more processing units for hydrogen production directly after stabilization of the crude oil. The stabilized crude oil is then subjected to stripping and upgrading processes in various treatment units.

In traditional stripping processes, a large amount of energy is required to heat the stripping gas, which traditionally includes steam and/or hydrogen. Additionally, a large amount of energy is required for cooling the stripping gas loaded with a hydrocarbon fraction that includes light hydrocarbons to promote condensation such that the stripping gas can be recovered from the volatilized light fraction. As such, traditional processes require high energy and cost expenditures. Since the manufacture of chemicals from crude oil does not necessarily require precisely regulated separations to make fuels, there remains a need to develop more energy efficient and sustainable manufacturing processes.

Embodiments herein relate to methods and systems that integrate hydrogen production with separation of hydrocarbon mixtures. Rather than transporting the natural gas directly to processing for hydrogen production, methods and systems of the present disclosure are directed to using energy within the natural gas stream and energy added to the natural gas stream to separate the crude oil into a bottoms stream and an overheads stream in a stripping unit.

More specifically, embodiments disclosed herein relate to a system and method for using a hydrogen manufacturing unit feedstock for separating wide-boiling hydrocarbon mixtures into a bottoms stream (e.g., heavy hydrocarbons not lifted by the stripping medium), and an overheads stream including the hydrogen manufacturing unit feedstock and low boiling hydrocarbons within the wide-boiling hydrocarbon mixture or whole crude.

Hydrocarbon mixtures useful in embodiments disclosed herein may include various hydrocarbon mixtures having a wide boiling point range, where the end boiling point of the mixture may be greater than 500° C., such as greater than 525° C., 550° C., or 575° C. The amount of high boiling hydrocarbons, such as hydrocarbons boiling over 550° C., may be as little as 0.1 wt %, 1 wt % or 2 wt %, but can be as high as 10 wt %, 25 wt %, 50 wt % or greater. The description is explained with respect to crude oil, such as whole crude oil, but any high boiling end point hydrocarbon mixture can be used. However, processes disclosed herein can be applied to crudes, condensates and hydrocarbons with a wide boiling curve and end points higher than 500° C. Such hydrocarbon mixtures may include crude desalted oils, whole crudes, virgin crudes, hydroprocessed crudes, gas oils, vacuum gas oils, heating oils, jet fuels, diesels, kerosenes, gasolines, synthetic naphthas, raffinate reformates, Fischer-Tropsch liquids, Fischer-Tropsch gases, natural gasolines, distillates, virgin naphthas, natural gas condensates, atmospheric pipestill bottoms, vacuum pipestill streams including bottoms, wide boiling range naphtha to gas oil condensates, heavy non-virgin hydrocarbon streams from refineries, vacuum gas oils, heavy gas oils, atmospheric residuum, hydrocracker wax, and Fischer-Tropsch wax, among others. In some embodiments, the hydrocarbon mixture may include hydrocarbons boiling from the naphtha range or lighter to the vacuum gas oil range or heavier.

When the end boiling point of the hydrocarbon mixture is high, such as over 550° C., the hydrocarbon mixture cannot be processed directly in a steam pyrolysis reactor to produce olefins. The presence of these heavy hydrocarbons results in the formation of coke in the reactor, where the coking may occur in one or more of the convection zone preheating coils or superheating coils, in the radiant coils, or in transfer line exchangers, and such coking may occur rapidly, such as in few hours. Whole crude is not typically cracked commercially, as it is not economical. It is generally fractionated, and only specific cuts are used in a steam pyrolysis heater to produce olefins. The remainder is used in other processes. The cracking reaction proceeds via a free radical mechanism. Hence, high ethylene yield can be achieved when it is cracked at high temperatures. Lighter feeds, like butanes and pentanes, require a high reactor temperature to obtain high olefin yields. Heavy feeds, like gas oil and vacuum gas oil (VGO), require lower temperatures. Crude contains a distribution of compounds from butanes to VGO and residue (material boiling over 550° C.). Subjecting the whole crude without separation at high temperatures produces a high yield of coke (byproduct of cracking hydrocarbons at high severity) and plugs the steam pyrolysis reactor. The steam pyrolysis reactor has to be periodically shut down and the coke is cleaned by steam/air decoking. The time between two cleaning periods when the olefins are produced is called run length. When whole crude is cracked without separation, coke can deposit in the convection section coils (vaporizing the fluid), in the radiant section (where the olefin producing reactions occur) and/or in the transfer line exchanger (where the reactions are stopped quickly by cooling to preserve the olefin yields).

The processes and systems herein may generate hydrogen for downstream hydroprocessing units internally such that no external hydrogen source or external fuel source (e.g., methane) for hydrogen production is necessary for chemical manufacturing. In some embodiments, a hydrogen manufacturing unit feedstock simplifies the crude-to-chemicals design process through integration of a natural gas, which may be recovered in downstream units for further processing, as the hydrogen manufacturing unit feedstock at crude separation stages. The systems and methods of one or more embodiments reduce the amount of equipment required and lower the carbon footprint and energy intensity of the overall process. The systems and methods disclosed herein may enhance separation efficiencies by utilizing a hydrogen manufacturing unit feedstock, such as an ultralight hydrogen manufacturing unit feedstock (e.g., methane, ethane, propane, or natural gas), instead of traditional stripping gases (e.g., steam and/or hydrogen).

In some embodiments, a wide boiling range hydrocarbon mixture, such as a whole crude, may be desalted, if necessary, and following desalting, may be fed to a hot hydrocarbon stripper. In the hot hydrocarbon stripper, the wide boiling range hydrocarbon may be contacted with the hydrogen manufacturing unit feedstock and separated into a light fraction, containing the hydrogen manufacturing unit feedstock and lower boiling hydrocarbons of the wide boiling hydrocarbon mixture, and a stripper bottoms, containing higher boiling hydrocarbons of the wide boiling hydrocarbon mixture that may be unsuitable for direct processing in a steam cracker. The stripper overheads may be cooled to recover the lower boiling hydrocarbons as a liquid and the hydrogen manufacturing unit feedstock as a vapor, both of which may be fed to downstream processing units for further processing, such as feeding of the stripping medium to a hydrogen production unit and feeding the lower boiling hydrocarbons to downstream units, such as a reactor or steam cracker used in processes as described herein for producing chemicals. A feed-effluent exchanger may be used to cool the stripper bottoms and pre-heat the wide boiling range hydrocarbon feed, if desired.

In some embodiments, the lower boiling hydrocarbons may include hydrocarbons boiling in a range up to 490° C., for example. In such instances, in addition to the stripper bottoms, it may be desirable to recover three fractions from the stripper overheads. For example, sequentially cooling the stripper overheads may be used to recover a medium boiling hydrocarbon fraction, a light boiling hydrocarbon fraction, and the hydrocarbon stripping medium.

In other embodiments, a wide boiling range hydrocarbon mixture, such as a whole crude, may be desalted, if necessary, and following desalting, may be further preheated in a heater to produce a preheated crude. The preheated crude may be fed to a separator which facilitates the separation of a light hydrocarbon fraction, such as a 160° C.− fraction, and a remaining liquid fraction. The light hydrocarbon fraction may be used directly as a feedstock to produce petrochemicals, such as feeding the light hydrocarbon fraction to a steam cracker. The remaining liquid fraction, for example those hydrocarbons having a boiling point of 160°+, may then be pumped to a heat exchanger, preheating the hydrocarbons against a hot stripper bottoms, producing a pressurized and a preheated remaining liquid fraction. The preheated remaining liquid fraction may then be fed back to the heater, where it may be further heated to facilitate separations. The remaining liquid fraction may then be fed to the stripper to separate the remaining liquid fraction into a stripper overheads, including the stripping medium and medium boiling hydrocarbon fraction, such as those boiling in the range of 160° C. to 490° C., from a stripper bottoms, containing the unvaporized higher boiling hydrocarbons. The stripper overheads may then be cooled to recover the stripping medium and the medium boiling hydrocarbon fraction, which may be fed to downstream reaction stages as described further herein. For example, the stripping medium may be fed to a hydrogen production unit, producing hydrogen for hydroprocessing of the medium boiling fraction, producing hydrogen for hydroprocessing of the stripper bottoms, or both.

The hydrocarbon stripping medium recovered following stripping of the wide boiling hydrocarbon mixture may be recycled, may be forwarded to hydrogen production, or both. In some embodiments, the wide boiling hydrocarbon mixture may include lighter hydrocarbons that may be recovered or entrained with the stripping medium. In such cases, a stripping medium recycle may be used to provide an amount of stripping medium in addition to fresh or make-up stripping medium, while excess and/or purge stripping medium recovered following the stripping steps may be forwarded for hydrogen production.

Depending upon the nature of the wide boiling hydrocarbon mixture, the light hydrocarbon fraction may be fed directly to chemicals production via steam cracking. In other embodiments, such as where a medium hydrocarbon fraction and a light hydrocarbon fraction are recovered, the light hydrocarbon fraction may be fed directly for chemicals production while the medium hydrocarbon fraction may undergo hydrotreatment, such as heteroatom removal among others, to condition the hydrocarbons therein for use in a steam cracker. The stripper bottoms, containing the most difficult compounds in the wide boiling hydrocarbon mixture, may be recovered and processed to also make the heavies suitable for chemicals production, where such additional processing may include liquid circulation, ebullated bed residue hydrocrackers, among other unit operations.

### Stripping System

In one aspect, embodiments disclosed herein relate to a stripping system used to separate (or “strip”) hydrocarbon streams from a wide boiling hydrocarbon mixture feed. The stripping system may include a hydrocarbon stripping medium, a stripping unit, a separation unit, a wide boiling hydrocarbon mixture feed, an overheads stream separation unitor combinations thereof. As one of ordinary skill may appreciate, the system may include various sensors, control units, piping, pumps, valves, etc.

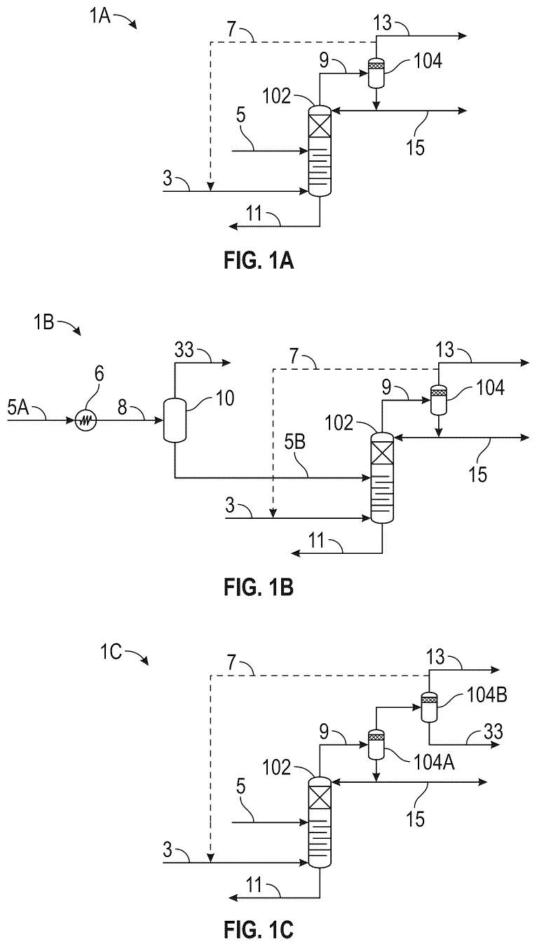

Referring now to FIG. 1A, a stripping system 1A useful in embodiments herein is illustrated. In the stripper 102, hydrocarbon mixture 5, such as a desalted crude or other wide boiling hydrocarbon mixture, is contacted with a stripping medium 3, such as hot natural gas (alternatively, methane, ethane, propane or a mixture thereof), to separate vaporizable hydrocarbons from the hydrocarbon mixture. The stripping medium 3 may comprise hydrocarbons intended for use or preheated for use in a hydrogen production unit (not illustrated). The stripping medium may be heated or superheated, and at a temperature sufficient to vaporize and lift hydrocarbons having a normal boiling point up to 220° C., for example, using the stripping medium. In some embodiments, the vaporized hydrocarbons may have an end boiling point in a range from about 150° C. to about 350° C., and in other embodiments may have an end boiling point in a range from about 140° C. to about 200° C., such as about 160° C. to 180° C. The remaining unvolatilized hydrocarbons may be recovered as a bottoms fraction via flow line 11 from the stripper, and a mixture of hydrogen and vaporized hydrocarbons may be recovered as an overheads fraction 9 from the stripper. The bottoms fraction may be fed to downstream units via flow line for further separation and/or hydroprocessing, as described further below, to produce olefins. The overheads fraction from stripper 102 are then partially condensed to separate the volatilized hydrocarbons from the stripping medium in separator 104 via flow line 9. A portion of the condensed hydrocarbons may be used as a reflux fed to stripper 102, and the remaining condensed hydrocarbons may be fed to downstream processing units via flow line 15, as will be described further, to produce olefins. The stripping medium recovered from separation unit 104 is then fed downstream, such as to a hydrogen production unit (not illustrated), via flow line 13. In some embodiments, the feed rate of the stripping medium may be in excess of that which is to be used in the hydrogen production unit, and the excess stripping medium may be recovered via flow line 7, and may be compressed, re-heated and circulated for continued use in the stripper.

Referring now to FIG. 1B, a stripping system useful in other embodiments herein is illustrated. A hydrocarbon mixture 5A is initially heated, such as in a convection zone of a fired heater or in an exchanger 6, to provide a heated hydrocarbon mixture 8. The heated hydrocarbon mixture is then fed to a separation system 10, such as a flash drum, stripper, an Advanced Separation Device (ASD), or a single stage Hot Oil Processing Scheme (HOPS) to separate volatilized hydrocarbons from the heated hydrocarbon mixture, recovering a light hydrocarbon stream via flow line 33 and a remaining hydrocarbon stream 5B. The remaining hydrocarbons, including medium boiling, easier to process hydrocarbons, and high boiling, harder to process hydrocarbons, are then fed to a stripper 102. In stripper 102, hydrocarbon mixture 5B, is contacted with a stripping medium 3, such as hot natural gas (alternatively, methane, ethane, propane or a mixture thereof), to separate vaporizable hydrocarbons from the hydrocarbon mixture. The stripping medium 3 may comprise hydrocarbons intended for use or preheated for use in a hydrogen production unit (not illustrated). The stripping medium may be heated or superheated, and at a temperature sufficient to vaporize and lift medium boiling hydrocarbons, such as those having a normal boiling point up to 480° C., for example, using the stripping medium. In some embodiments, the vaporized medium boiling hydrocarbons may have an end boiling point in a range from about 280° C. to about 480° C., and in other embodiments may have an end boiling point in a range from about 350° C. to about 460° C. The remaining unvolatilized heavy hydrocarbons may be recovered as a bottoms fraction from the stripper via flow line 11, and a mixture of hydrogen and vaporized medium boiling hydrocarbons may be recovered as an overheads fraction from the stripper via flow line 9. The bottoms fraction may be fed to downstream units for further separation and/or hydroprocessing via flow line 11, as described further below, to produce olefins. The overheads fraction from stripper 102 are then partially condensed to separate the volatilized medium boiling hydrocarbons from the stripping medium in separator 104 via flow line 9. A portion of the condensed medium boiling hydrocarbons may be used as a reflux fed to stripper 102, and the remaining condensed medium boiling hydrocarbons may be fed to downstream processing units via flow line 15, as will be described further, to produce olefins. The stripping medium recovered from separation unit 104 is then fed downstream, such as to a hydrogen production unit (not illustrated), via flow line 13. In some embodiments, the feed rate of the stripping medium may be in excess of that which is to be used in the hydrogen production unit, and the excess stripping medium may be recovered via flow line 7, and may be compressed, re-heated and circulated for continued use in the stripper.

In some embodiments, as illustrated in FIG. 1C, a stripping system 1C may include a two stage condensation system, such as with separation units 104A and 104B, providing recovery of at least two light hydrocarbon cuts that may be recovered by flow lines 13 and 33 from 104B, and a medium boiling fractions by flow line 15 from 104A in addition to high boiling fraction, which may be recovered via flow line 11.

The above-described stripping systems 1A, 1B, and 1C may be used for effectively and efficiently converting hydrocarbons contained in the wide boiling hydrocarbon mixture to olefins. For example, a light hydrocarbon cut may be recovered by flow lines 33, 15 (some embodiments), that comprises compounds easy to crack and that do not rapidly foul exchangers or cracking coils, may be fed to a steam cracking unit for production of olefins. Higher boiling fractions may be recovered by flow lines 11, 15 (other embodiments) that may include various contaminants (sulfur, nitrogen, metals) and compounds that tend to promote fouling (such as asphaltenes) may be routed to hydroprocessing units to convert the medium and higher boiling fractions to feeds that are suitable for steam cracking.

### Integration of a Stripping System

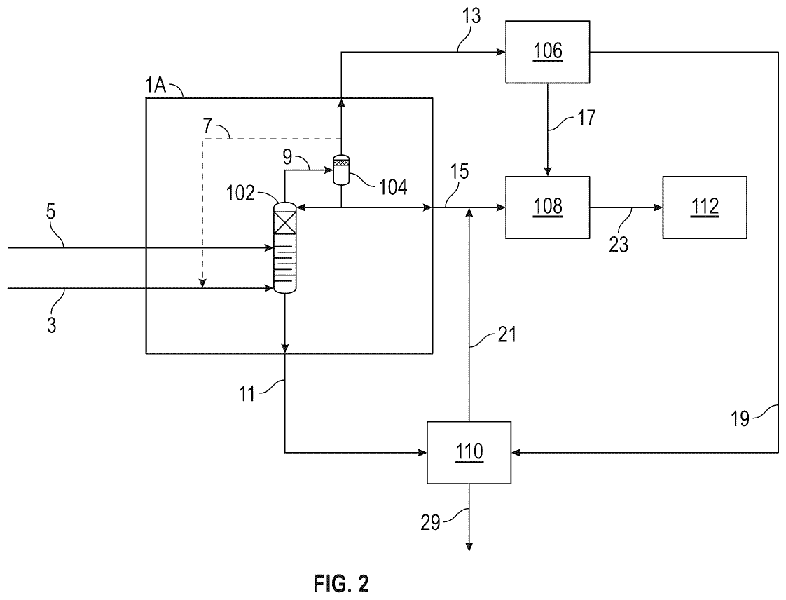

In another aspect, embodiments disclosed herein relate to systems and/or processes that integrate a stripping system as described above. The systems and/or processes that integrate a stripping system may include hydrocarbon production systems and processes, such as an olefin production system. FIG. 2 is an example of a simplified process flow diagram of a system for producing olefins incorporating a stripping system 1A in accordance with one or more embodiments. The system for producing olefins includes a stripping system 1A that includes a stripping unit 102 and a separation unit 104, a hydrogen manufacturing unit 106, a first hydroprocessing unit 110, a second hydroprocessing unit 108 and a steam cracker 112. The stripping unit 102 may be in fluid communication with a hydrocarbon stripping medium source (not shown) via hydrocarbon stripping medium inlet line 3. In some embodiments, the hydrocarbon stripping medium inlet line 3 is in fluid communication with the separation unit 104 via recycled hydrocarbon stripping medium line 7. The stripping unit 102 may be in fluid communication with a hydrocarbon mixture source (not shown) via a hydrocarbon mixture inlet line 5.

A temperature of the hydrocarbon mixture feed, the hydrogen stripping medium feed, or both may be in a range from 200° C. to 450° C. For example, the temperature of the hydrocarbon mixture feed, the hydrogen stripping medium feed, or both may be in a range with a lower limit of any one of 200° C., 225° C., 250° C., 275° C., or 300° C. and an upper limit of any one of 250° C., 275° C., 300° C., 325° C., 350° C., 375° C. 400° C., 425° C., or 450° C., where any upper limit can be paired with any mathematically compatible upper limit.

In some embodiments, the stripping medium is a feedstock for a hydrocarbon manufacturing unit. The hydrocarbon stripping medium routed to stripping unit 102 may include light hydrocarbons. In some embodiments, the hydrocarbon stripping medium routed to stripping unit 102 may include ultralight hydrocarbons, such as hydrocarbons being fed to a hydrogen manufacturing unit. The term “ultralight hydrocarbons” refers to a hydrocarbon stripping medium that includes paraffinic hydrocarbons of C₄ and lower. The hydrocarbon stripping medium may include hydrocarbons in the range of C₁ to C₄. The hydrocarbon stripping medium may include hydrocarbons in the range of C₁ to C₃. In other embodiments, the hydrocarbon stripping medium may include C₁ to C₂ hydrocarbons or may be methane. In some embodiments, the hydrocarbon stripping medium is a natural gas that has been removed from a crude oil during one or more upstream processes. In some embodiments, the hydrocarbon stripping medium includes an ultralight hydrocarbon that has been recovered and recycled from an overheads stream produced by the stripping unit 102. The hydrocarbon mixture passed to stripping unit 102 may include a mixture of hydrocarbons, such as a desalted crude oil, or various wide boiling hydrocarbon mixtures as described above, or combinations thereof.

Stripping unit 102 may include operational systems and be operated at parameters to provide broad flexibility of stripping conditions. For example, stripping unit 102 may be configured to adjust operation based on the nature of the hydrocarbon stripping medium and the wide boiling hydrocarbon feedstock that is being processed. In some embodiments, the stripping unit 102 is configured to produce at least two effluent streams (e.g., an overheads stream and a bottoms stream). The separation unit 104 may include at least two outlet lines to pass the volatilized hydrocarbons (via overheads outlet line 13) and the bottoms stream (via bottoms outlet line 11) to one or more treatment units (e.g., hydroprocessing units 108, 110) for further processing, or for direct feed (not illustrated) of the light volatilized hydrocarbons to steam cracker unit 112.

As shown in FIG. 2, separation unit 104 may be located downstream of and in fluid communication with stripping unit 102 via an overhead stream transport line 9. In some embodiments, the separation unit 104 includes operational parameters such that the overheads stream is separated into a light boiling hydrocarbon fraction, a middle boiling hydrocarbon fraction, the hydrogen manufacturing unit feedstock, or combinations thereof. The separation unit 104 may include operational parameters such that the hydrogen manufacturing unit feedstock is separated from the light hydrocarbon stream. The separation unit 104 may separate the hydrogen manufacturing unit feedstock from the overheads stream.

The light hydrocarbon stream may include a light cut having a boiling point of 220° C. or less, which can be routed to downstream processes, such as steam cracking, via separated hydrocarbon feed line. In some embodiments, a middle cut having a boiling point of 160° C. or more can be routed to a hydroprocessing unit (e.g., the second hydroprocessing unit 108) via separated hydrocarbon feed line 15.

The first hydroprocessing unit 110 may be configured to receive the bottoms stream from stripping unit 102 via bottoms stream feed line 11 and a hydrogen stream fed via feed line 19. The bottoms stream from the stripping unit, including the heavy boiling hydrocarbons, may be treated (e.g., hydroprocessed) using the first hydroprocessing unit 110 to produce a first effluent. The first hydroprocessing unit 110 may be configured to recover and process a bottoms stream from the stripping unit by liquid circulation, ebullated bed residue hydrocracking, along with any additional low value refinery streams, such as a pyoil stream and/or a slurry oil stream. Non-limiting examples of residue hydrocracking may be performed in a fixed bed residue hydrocracker, an LC-FINING or LC-MAX reactor system, and slurry reactors (e.g., LC-SLURRY reactors), each available from Chevron Lummus Global. It is recognized, however, that the lifetime of destructive hydrogenation and/or hydrocracking catalysts may be negatively impacted by heavier components, such as where the feed includes components boiling above 565° C., for example. Similar to the mid-cut, division of the heavy cut into one or more sub-cuts is also contemplated.

In some embodiments, the first effluent includes light boiling hydrocarbons, middle boiling hydrocarbons, or a mixture thereof that can be routed to the second hydroprocessing unit 108, for conversion to a petrochemical feedstock. For example, the first effluent routed to the second hydroprocessing unit 108 may be further treated, either in combination with the separated light hydrocarbon stream or alone, to form a petrochemical feedstock.

Separation unit 104 may be upstream of and in fluid communication with a hydrogen manufacturing unit 106 via a recovered hydrogen manufacturing unit feedstock feed line 13. The hydrogen manufacturing unit 106 may be configured to produce hydrogen from at least a portion of the recovered hydrogen manufacturing unit feedstock. The hydrogen manufacturing unit 106 may be configured to produce a hydrogen stream from a first portion of the separated hydrogen manufacturing unit feedstock. In such embodiments, a second portion of the separated hydrogen manufacturing unit feedstock is recycled from the separation unit 104 to the stripping unit 102 via recycle line 7.

The hydrogen manufacturing unit 106 may be in fluid communication with one or more hydroprocessing units via one or more hydrogen feed lines (e.g., lines 17 and 19). The one or more hydrogen feed lines may be configured to feed the hydrogen stream from the hydrogen manufacturing unit to the first hydroprocessing unit 110, the second hydroprocessing unit 108, or combinations thereof. In some embodiments, the hydrogen manufacturing unit 106 is upstream of and in fluid communication with at least two hydroprocessing units via the one or more hydrogen feed lines. For example, the hydrogen manufacturing unit 106 of FIG. 2 is in fluid communication with a second hydroprocessing unit 108 via hydrogen feed line 17, and the hydrogen manufacturing unit 106 is in fluid communication with a first hydroprocessing unit 110 via hydrogen feed line 19.

The second hydroprocessing unit 108 may be in fluid communication with the separation unit 104 via a feed line 15 such that the second hydroprocessing unit 108 is configured to receive a separated hydrocarbon fraction that includes middle boiling hydrocarbons from the separation unit 104. In some embodiments, the second hydroprocessing unit 108 is in fluid communication with the first hydroprocessing unit 110. For example, the first hydroprocessing unit 110 may be in fluid communication with the feed line 15 via feed line 21 as shown in FIG. 2. Feed line 21 may be configured to feed the first effluent from the first hydroprocessing unit 110 to the second hydroprocessing unit 108. As such, the second hydroprocessing unit 108 may be configured to receive at least two hydrocarbon feeds, such as a middle boiling hydrocarbon feed from the separation unit 104 and a first effluent that includes middle boiling hydrocarbons from the first hydroprocessing unit 110. In such embodiments, the hydrocarbon feed received from separation unit 104 and the first effluent from the first hydroprocessing unit 110 can be mixed prior to introduction to the second hydroprocessing unit 108. In some embodiments, the mixed hydrocarbon feeds are heated prior to introduction into the second hydroprocessing unit.

The one or more hydroprocessing units may include reactors including catalysts for metals removal, sulfur removal, nitrogen removal, and the conditioning in these reactors may overall add hydrogen to the hydrocarbon components, making them easier to process downstream to produce petrochemicals. The hydroprocessing unit receiving the bottoms stream (e.g., the first hydroprocessing unit 110), the middle boiling hydrocarbons (e.g., the second hydroprocessing unit 108), or both may contain different layers of demetallizing, destructive hydrogenation and mesoporous zeolite hydrocracking catalysts to optimize the conversion of the heavy materials to a balance between a highly paraffinic stream that is suitable for olefins production and a rich in aromatics stream that is suitable for aromatics production.

The one or more hydroprocessing units of the stripping system may include catalytic reactors or non-catalytic reactors. In some embodiments, the one or more hydroprocessing units of the stripping system include hydrotreating units, hydrocracking units, or combinations thereof. As one of ordinary skill may appreciate, hydrotreating is a catalytic process that is usually carried out in the presence of free hydrogen, in which the primary purpose when used to process hydrocarbon feedstocks is the removal of various metal contaminants (e.g., arsenic), heteroatoms (e.g., sulfur, nitrogen and oxygen), and aromatics from the feedstock.

Generally, in hydrotreating operations cracking of the hydrocarbon molecules (i.e., breaking the larger hydrocarbon molecules into smaller hydrocarbon molecules) is minimized. As used herein, the term “hydrotreating” refers to a refining process whereby a feed stream is reacted with hydrogen gas in the presence of a catalyst to remove impurities such as sulfur, nitrogen, oxygen, and/or metals (e.g., nickel, or vanadium) from the feed stream (e.g., the atmospheric tower bottoms) through reductive processes. Hydrotreating processes may vary substantially depending on the type of feed to a hydrotreater. For example, light feeds (e.g., naphtha) contain very little and few types of impurities, whereas heavy feeds (e.g., ATBs) typically possess many different heavy compounds present in a crude oil. Apart from having heavy compounds, impurities in heavy feeds are more complex and difficult to treat than those present in light feeds. Therefore, hydrotreating of light feeds is generally performed at lower reaction severity, whereas heavy feeds require higher reaction pressures and temperatures.

Hydrocracking refers to a process in which hydrogenation accompanies the cracking/fragmentation of hydrocarbons, e.g., converting heavier hydrocarbons into lighter hydrocarbons, or converting aromatics and/or cycloparaffins (naphthenes) into non-cyclic branched paraffins.

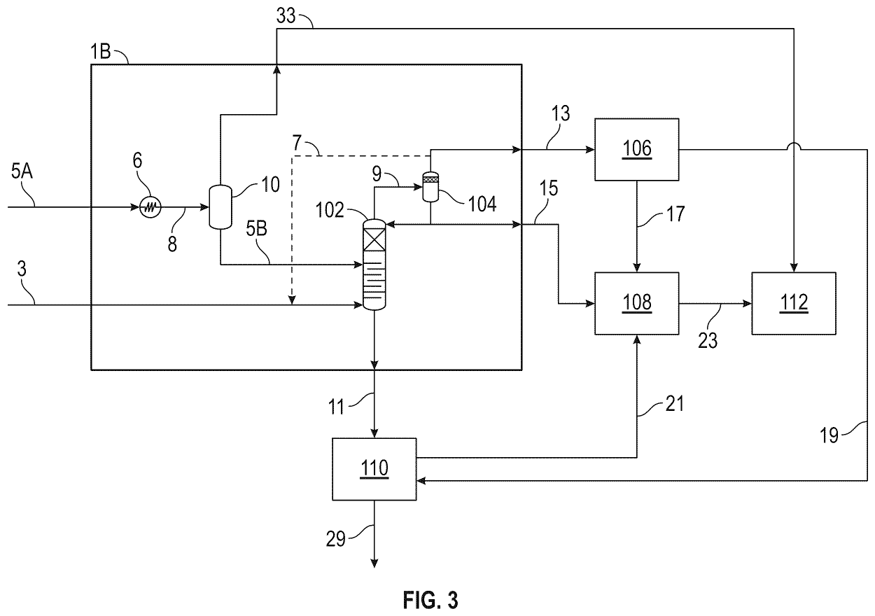

FIG. 3 is an example of a simplified process flow diagram of a system for producing olefins incorporating a stripping system 1B in accordance with one or more embodiments. As shown in FIG. 3, the system for producing olefins includes a stripping system 1B, a hydrogen manufacturing unit 106, a first hydroprocessing unit 110, a second hydroprocessing unit 108, and a steam cracker 112. The hydrogen manufacturing unit 106, the first hydroprocessing unit 110, the second hydroprocessing unit 108, and the steam cracker 112 may be as described above.

The stripping system 1B includes a separation unit 104, a stripping unit 102, and a separation system 10. In such embodiments, stripping unit 102 is a multi-stage stripping unit to provide three or more effluent streams. As shown in FIG. 3, the stripping unit 102 may be a two-stage stripping system that includes at least three outlet lines (e.g., lines 11, 13, and 15) and produces at least three effluent streams. In such embodiments, the at least three effluent streams include a bottoms stream, a middle hydrocarbon stream, and an overheads stream. A light hydrocarbon cut feed line 33 that may recover a light hydrocarbon cut from the separation system 10 of the stripping system 1B. The light hydrocarbon cut may be fed to a steam cracker via feed line 33.

The separation unit 104 may include a light boiling hydrocarbon feed line 13 for routing an overheads stream of the separation unit, which may include a light cut having a boiling point of 160° C. or less, to downstream processes, such as a hydrogen manufacturing unit 106. The separated middle boiling hydrocarbons having a boiling point of 160° C. or more may be routed to the second hydroprocessing unit 108 via outlet line 15 from separation system 1B. The bottoms stream may be passed to one or more treatment units (e.g., a first hydroprocessing unit) via outlet line 11.

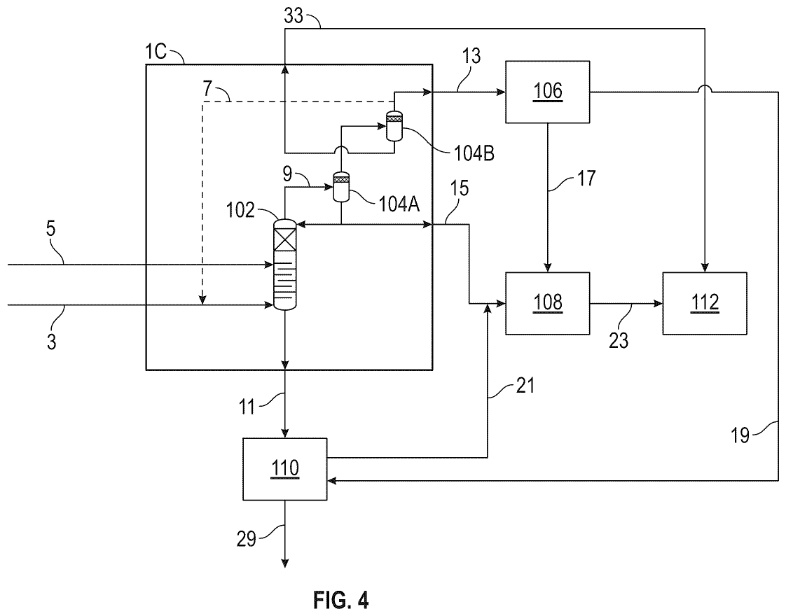

FIG. 4 is an example of a simplified process flow diagram of a system for producing olefins incorporating a stripping system 1C in accordance with one or more embodiments. As shown in FIG. 4, the system for producing olefins includes a stripping system 1C, a hydrogen manufacturing unit 106, a first hydroprocessing unit 110, a second hydroprocessing unit 108, and a steam cracker 112. The hydrogen manufacturing unit 106, the first hydroprocessing unit 110, the second hydroprocessing unit 108, and the steam cracker 112 may be as described above.

As shown in FIG. 4, the system includes a stripping system 1C having a two-stage condensation system (e.g., units 104A and 104B) that provide recovery of a light hydrocarbon cut 33, and a medium boiling fractions 15 in addition to high boiling fraction 11. The separation unit 104B may include a light boiling hydrocarbon feed line 13 for routing an overheads stream of the separation unit 104B, which may include a light cut having a boiling point of 160° C. or less, to downstream processes, such as a hydrogen manufacturing unit 106. As shown in FIG. 4, the separation unit 104B may include a light boiling hydrocarbon feed line 33 for routing a light cut having a boiling point of 160° C. or less to downstream processes, such as steam cracker 112. The separated middle boiling hydrocarbons having a boiling point of 160° C. or more may be routed to the second hydroprocessing unit 108 via outlet line 15 from separation unit 104A.

In some embodiments, an overhead stream produced from the stripping unit is a mixture of the hydrogen manufacturing unit feedstock and a light hydrocarbon stream. In other embodiments, the overhead stream from the stripping unit is a mixture of the hydrogen manufacturing unit feedstock and a medium hydrocarbon stream. In some embodiments, the overhead stream produced from the stripping unit is a mixture of the hydrogen manufacturing unit feedstock, a light hydrocarbon stream, and a middle hydrocarbon stream. An additional separation step, such as a two stage condensation system, may then be used to separate a middle hydrocarbon stream that includes a middle boiling fraction from the light hydrocarbon stream (i.e., light boiling components), each recovered separately from the stripping medium. In such embodiments, the recovered light hydrocarbon stream can be fed directly to a steam cracker for chemicals production while the recovered medium hydrocarbon stream may undergo hydrotreatment, such as heteroatom removal among others, to condition the hydrocarbons therein for use in a steam cracker.

Accordingly, in some embodiments, the light hydrocarbon stream (or “light fraction”) may include hydrocarbons having a boiling point up to about 90° C., up to about 100° C., up to about 110° C., up to about 120° C., up to about 130° C., up to about 140° C., up to about 150° C., up to about 160° C., up to about 170° C., up to about 180° C., up to about 190° C., up to about 200° C., up to about 210° C., up to about 220° C., up to about 230° C., up to about 240° C., up to about 250° C., up to about 300° C., up to about 350° C., up to about 360° C., up to about 400° C., or up to about 500° C. The light hydrocarbon stream may include hydrocarbons having a boiling point in a range from about 90° C. to about 500° C. Embodiments herein also contemplate the light hydrocarbon stream being hydrocarbons having boiling points up to temperatures intermediate the aforementioned ranges.

Depending upon the fractionation conditions of stripping unit, the separation conditions of separation unit, or both, the hydrocarbon “cut” for the light fraction may be relatively clean, meaning the light cut may not have any substantial amount (>1 wt %) of compounds boiling above the intended boiling temperature target limits. For example, a light hydrocarbon stream may not have any substantial amount of hydrocarbon compounds boiling above 500° C. In some embodiments, a light cut may not have any substantial amount of hydrocarbon compounds boiling above 500° C. In other embodiments, the intended target “cut” temperatures noted above may be a 5 wt % or 15 wt % boiling point temperature on the lower limit and/or a 95% or 85% boiling point temperature on the upper limit, such as may be measured using ASTM D86 or ASTM D2887, or a True Boiling Point (TBP) analysis according to ASTM D2892, for example, and ASTM D7169 for heavy streams, such as those boiling above about 500° C. In such embodiments, there may be up to 5 wt % or up to 15 wt % of compounds above and/or below the “cut” point temperature, respectively.

The middle hydrocarbon stream (or “middle fraction”) may include hydrocarbons having a boiling point from a lower limit of the light hydrocarbon upper temperature (e.g., 90° C., 100° C., 110° C., 120° C., 130° C., 140° C., 150° C., 160° C., 170° C., 180° C., 190° C., 200° C., 210° C., 220° C., 230° C., 240° C., 250° C., 300° C., 350° C., 400° C., or 500° C. for example) to an upper limit of hydrocarbons having a boiling point up to about 350° C., up to about 375° C., up to about 400° C., up to about 410° C., up to about 420° C., up to about 430° C., up to about 440° C., up to about 450° C., up to about 460° C., up to about 480° C., up to about 490° C., up to about 500° C., up to about 520° C., up to about 540° C., up to about 560° C., or up to about 580° C. In some embodiments, the middle hydrocarbon stream includes a low-mid cut, a high-mid cut, or both. A low-mid cut may include hydrocarbons in a boiling range from about 160° C. to about 360° C. A high-mid cut may include hydrocarbons in a boiling range from about 360° C. to about 500° C. Embodiments herein also contemplate the middle fraction being hydrocarbons having boiling points from and/or up to temperatures intermediate the aforementioned ranges.

Depending upon the fractionation conditions of stripping unit, the separation conditions of separation unit, or both, the hydrocarbon “cut” for the middle fraction may be relatively clean, meaning the middle cut may not have any substantial amount (>1 wt %) of compounds boiling above the intended boiling temperature target limits. For example, a light hydrocarbon stream including a middle cut may not have any substantial amount of hydrocarbon compounds boiling above 500° C. In some embodiments, a middle cut may not have any substantial amount of hydrocarbon compounds boiling above 500° C. In other embodiments, the intended target “cut” temperatures noted above may be a 5 wt % or 15 wt % boiling point temperature on the lower limit and/or a 95% or 85% boiling point temperature on the upper limit, such as may be measured using ASTM D86 or ASTM D2887, or a True Boiling Point (TBP) analysis according to ASTM D2892, for example, and ASTM D7169 for heavy streams, such as those boiling above about 500° C. In such embodiments, there may be up to 5 wt % or up to 15 wt % of compounds above and/or below the “cut” point temperature, respectively.

The bottoms stream produced from the stripping unit is a heavy hydrocarbon stream. In some embodiments, the heavy fraction (bottoms stream) may include hydrocarbons having a boiling point above about 300° C., above about 375° C., above about 400° C. (e.g., a 400° C.+ fraction), above about 420° C., above about 440° C., above about 460° C., above about 480° C., above about 490° C., above about 500° C., above about 510° C., above about 520° C., above about 530° C., above about 540° C., above about 560° C., above about 580° C., above about 590° C., above about 600° C. (e.g., a 600° C.+ fraction), or above about 700° C. Embodiments herein also contemplate the heavy fraction being hydrocarbons having boiling points above temperatures intermediate the aforementioned temperatures.

Depending upon the fractionation conditions of stripping unit, the separation conditions of separation unit, or both, the heavy hydrocarbon “cut” may be relatively clean, meaning the heavy fraction may not have any substantial amount (>1 wt %) of compounds boiling below the intended boiling temperature target. For example, a 500° C.+ cut may not have any substantial amount of hydrocarbon compounds boiling below 500° C. In other embodiments, the intended target “cut” temperatures noted above may be a 95% boiling point temperature, or in other embodiments as an 85% boiling point temperature, such as may be measured using ASTM D86 or ASTM D2887, or a True Boiling Point (TBP) analysis according to ASTM D2892, for example, and ASTM D7169 for heavy streams, such as those boiling above about 500° C. In such embodiments, there may be up to 5 wt % or up to 15 wt % of compounds, respectively, below the “cut” point temperature.

### Method for Stripping a Hydrocarbon Mixture and Producing a Petrochemical Feedstock

In another aspect, embodiments disclosed herein are directed to an integrated process for stripping a hydrocarbon mixture feed into different fractions and producing a petrochemical feedstock. The separations of one or more embodiments may depend upon the crude feed being separated (e.g., condensates, ultralight crude oil, Arab light crude, west Texas intermediate, tar sands, etc.), as well as the associated downstream processing units. The process for stripping a wide boiling hydrocarbon mixture of one or more embodiments uses a stripping system as previously described. In some embodiments, a hydrocarbon stripping medium and the hydrocarbon mixture feed are fed to a stripping unit. The process of one or more embodiments can include heating a wide boiling hydrocarbon mixture to a first temperature to produce a heated wide boiling hydrocarbon mixture, separating a light boiling hydrocarbon fraction from the heated wide boiling hydrocarbon mixture to recover a light hydrocarbon fraction and the hydrocarbon mixture, and feeding the hydrocarbon mixture to the stripping unit as the portion of the wide boiling hydrocarbon mixture. In some embodiments, a recycled hydrocarbon stripping medium is fed to a stripping unit from a separation unit.

The stripping unit may be operated to produce an overhead stream and a bottoms stream. In the stripping unit, the hydrocarbon mixture feed is separated (or “stripped”) into at least an overhead stream and a bottoms stream. As such, operating the stripping unit that includes the hydrocarbon stripping medium and the wide boiling hydrocarbon mixture feed forms a bottoms stream and an overhead stream that includes a mixture of the hydrocarbon stripping medium and a light hydrocarbon stream. In this manner, a light hydrocarbon stream may be stripped from a heavy hydrocarbon stream of the hydrocarbon mixture feed.

Operating the stripping unit may include adjusting one or more parameters to separate hydrocarbon streams of the hydrocarbon mixture feed based on boiling point range. Operating the stripping unit may include reducing a partial pressure of one or more hydrocarbons in the stripping unit. The hydrocarbon stripping medium of one or more embodiments may decrease a partial pressure of a hydrocarbon mixture feed to separate lighter hydrocarbons with lower boiling points (e.g., a lighter hydrocarbon stream) from the heavy hydrocarbons with higher boiling points. In some embodiments, the stripping unit provides an overhead stream, a middle boiling hydrocarbon fraction, and a bottoms stream. The middle boiling hydrocarbon fraction may be fed to one or more hydroprocessing units to produce a petrochemical feedstock.

The overheads stream may be fed to one or more units downstream of the stripping unit. The overhead stream may be cooled, to recover the ultralight hydrocarbon stripping medium. The overhead stream may be fed to a separator, which may facilitate the separation of the light boiling hydrocarbons from the hydrocarbon stripping medium of the overhead stream. Embodiments in which the overhead stream comprises middle boiling hydrocarbons, the separation unit can recover a middle boiling hydrocarbon fraction for processing in one or more processing units.

In some embodiments, the separation unit facilitates a simple separation, condensing out and recovering the stripped hydrocarbons, producing a stripping medium stream and a light hydrocarbon stream. In some embodiments, the separation unit facilitates a separation of the overheads stream to produce two or more cuts. For example, the separation unit may condense a middle fraction and then a light fraction in a stagewise manner, thereby providing two liquid hydrocarbon streams and a vaporous stripping medium stream. The two liquid hydrocarbon streams may then be fed to downstream processing. In some embodiments, the hydrocarbon stripping medium does not require energy-intensive heating and condensation to separate the hydrocarbon stripping medium.

In some embodiments, a light hydrocarbon stream having a boiling point of 160° C. or less does not require upgrading (e.g., hydroprocessing), and thus, can be directly routed a steam cracker and/or an aromatics complex. A recovered light hydrocarbon stream without a significant amount of halogens, metals, or heteroatoms may be straight run to a steam cracker and/or the aromatics complex, while medium hydrocarbons may be subjected to processing in a first hydroprocessing unit to remove problematic atoms, contaminants, or both upstream of a steam cracker.

In some embodiments, a portion or all of the hydrocarbon stripping medium may be recycled back to the stripping unit. In some embodiments, a portion or all of the hydrocarbon stripping medium is passed to a hydrogen manufacturing unit to produce hydrogen. In some embodiments, the hydrocarbon stripping medium is recovered from an overhead stream as a vapor product in the separation unit. The separated stripping medium may be recycled for continued use as a stripping medium or may be forwarded for hydrogen production.

In some embodiments, a portion of the light hydrocarbon stream can include ultralight hydrocarbons that can be recovered with the hydrocarbon stripping medium. If there are any excess ultralight hydrocarbons in the hydrocarbon mixture, then that excess may be captured with the recycled stripping medium. In some embodiments, a recycled hydrocarbon stripping medium including ultralight hydrocarbon excess from a crude oil feed may be fed to hydrogen production (e.g., a hydrogen manufacture unit), thereby ensuring that a stripping system includes a sufficient amount of ultralight hydrocarbons fed to a hydrocarbon manufacture unit to produce the total amount of hydrogen gas necessary for destructively hydrogenating middle and heavy fractions.

The hydrogen manufacturing unit may produce a hydrogen stream via steam and/or methane reforming from the stripping medium. The hydrogen stream produced from the ultralight hydrocarbon stripping medium may have a hydrogen gas molar purity of at least 99% or above. The generated hydrogen stream may be fed to a pressure swing adsorption (PSA) unit, an amine treatment, or both to improve the hydrogen purity. The PSA hydrogen product may be compressed in a make-up hydrogen compressor to provide the make-up hydrogen for the one or more hydroprocessing units. The hydrogen produced from hydrogen manufacturing unit may be routed to intermediate hydroprocessing reaction stages including one or more hydroprocessing units as appropriate.

The one or more hydroprocessing units may receive at least a portion of the hydrogen gas stream generated from the hydrogen manufacturing unit via one or more hydrogen feed lines to form a petrochemical feedstock from separated light hydrocarbons, a first effluent formed from the bottoms stream of the stripping unit, or combinations thereof. For example, a first hydroprocessing unit may receive the bottoms stream recovered from the stripping unit and at least a portion of the hydrogen stream generated from the hydrogen manufacturing unit. The bottoms stream may be processed to produce a petrochemical feedstock. In other embodiments, the first hydroprocessing unit processes the bottoms stream to produce a first effluent that includes middle boiling hydrocarbons. The middle boiling hydrocarbons may be feed to an additional hydroprocessing unit for further processing to produce a petrochemical feedstock.

While examples above are given with respect to limited temperature ranges, it is envisioned that any of the temperature ranges prescribed above can be used in the processes described herein. Further, with respect to cut points, those referred to one or more embodiments may be clean, as previously described, or may refer to 5% or 15% boiling temperatures for lower limits, or may refer to 85% or 95% boiling temperatures for upper limits.

Embodiments of the present disclosure may provide at least one of the following advantages. One or more embodiments may reduce greenhouse gas emissions via generation of a hydrogen stream internally. As such, external hydrogen consumption may be reduced, which may reduce the external consumption of methane from steam/methane reforming. Separation of fractions, such as a low boiling fraction and a high boiling fraction may enhance the capital efficiently and operating costs of the processes and systems disclosed herein. While referring to two cuts in many embodiments herein, it is recognized by the present inventors that condensates, typically having a small amount of high boiling components, and whole crudes, having a greater quantity of high boiling components, may be processed differently. Accordingly, one, two, three or more individual cuts can be performed for the wide boiling range petroleum feeds, and each cut can be processed separately at optimum conditions.

Although only a few example embodiments have been described in detail above, those skilled in the art will readily appreciate that many modifications are possible in the example embodiments without materially departing from this invention. Accordingly, all such modifications are intended to be included within the scope of this disclosure as defined in the following claims.

We claim:

1. A process for processing a wide boiling hydrocarbon mixture, the process comprising:
heating a hydrogen manufacturing unit feedstock to produce a heated hydrogen manufacturing unit feedstock;
stripping a wide boiling range hydrocarbon mixture with the heated hydrogen manufacturing unit feedstock to produce an overheads stream comprising a mixture of the hydrogen manufacturing unit feedstock and volatilized hydrocarbons and a bottoms stream comprising non-volatilized hydrocarbons;
separating the overheads stream to recover a non-condensed stream comprising the hydrogen manufacturing unit feedstock and a condensed stream comprising the volatilized hydrocarbons;
feeding the non-condensed stream to a hydrogen manufacturing unit.

2. The process of claim 1, further comprising producing hydrogen from the non-condensed stream in the hydrogen manufacturing unit.

3. The process of claim 2, further comprising reacting hydrogen produced in the hydrogen manufacturing unit with the non-volatilized hydrocarbons in a hydroprocessing unit to produce a hydroprocessed hydrocarbon stream.

4. The process of claim 3, further comprising steam cracking the condensed stream comprising the volatilized hydrocarbons and the hydroprocessed hydrocarbon stream to produce olefins.

5. The process of claim 1, wherein the hydrogen manufacturing unit feedstock comprises methane, ethane, propane, or natural gas.

6. A process for stripping a wide boiling hydrocarbon mixture and producing a petrochemical feedstock, the process comprising:
feeding a hydrogen manufacturing unit feedstock and a wide boiling hydrocarbon mixture or a portion thereof to a stripping unit;
recovering from the stripping unit an overhead stream comprising a mixture of the hydrogen manufacturing unit feedstock and light boiling hydrocarbons of the hydrocarbon mixture and a bottoms stream comprising heavier boiling hydrocarbons of the hydrocarbon mixture,
feeding the overhead stream from the stripping unit to a separation unit;
separating the hydrogen manufacturing unit feedstock from the light boiling hydrocarbons, recovering a separated hydrogen manufacturing unit feedstock stream and a stripped hydrocarbon stream;
feeding a first portion of the separated hydrogen manufacturing unit feedstock stream to a hydrogen manufacturing unit to produce a hydrogen stream; and
feeding a first portion of the hydrogen stream and the bottoms stream to a first hydroprocessing unit to produce the petrochemical feedstock.

7. The process of claim 6, further comprising:
heating a wide boiling hydrocarbon mixture to a first temperature to produce a heated wide boiling hydrocarbon mixture;
separating a light boiling hydrocarbon fraction from the heated wide boiling hydrocarbon mixture to recover a light hydrocarbon fraction and the hydrocarbon mixture;
feeding the hydrocarbon mixture to the stripping unit as the portion of the wide boiling hydrocarbon mixture.

8. The process of claim 6, wherein the hydrogen manufacturing unit feedstock comprises methane, ethane, propane, or a mixture of two or more of methane, ethane, and propane.

9. The process of claim 1, further comprising:
recycling a second portion of the separated hydrogen manufacturing unit feedstock to the stripping unit.

10. The process of claim 6, wherein the hydrogen manufacturing unit produces a total amount of hydrogen required by the first hydroprocessing unit.

11. The process of claim 7, further comprising:
feeding the stripped hydrocarbon mixture from the stripping unit to a second hydroprocessing unit; and
recovering a first effluent comprising a hydroprocessed fraction from the second hydroprocessing unit.

12. The process of claim 11, further comprising feeding a second portion of the hydrogen stream to the second hydroprocessing unit, wherein the hydrogen manufacturing unit produces a total amount of hydrogen required by the first hydroprocessing unit and the second hydroprocessing unit.

13. A process for producing a petrochemical feedstock from a wide boiling hydrocarbon mixture feed, the process comprising:
feeding a hydrogen manufacturing unit feedstock and a wide boiling hydrocarbon mixture or a portion thereof to a stripping unit;
recovering from the stripping unit an overhead stream comprising a mixture of the hydrogen manufacturing unit feedstock, light boiling hydrocarbons of the hydrocarbon mixture, medium boiling hydrocarbons of the hydrocarbon mixture, and a bottoms stream comprising heavier boiling hydrocarbons of the hydrocarbon mixture;
feeding the overhead stream from the stripping unit to a separation unit;
separating the hydrogen manufacturing unit feedstock from the light boiling hydrocarbons;
feeding a portion of the separated hydrogen manufacturing unit feedstock stream to a hydrogen manufacturing unit to produce a hydrogen stream;
feeding a first portion of the hydrogen stream and the bottoms stream to a first hydroprocessing unit to produce a first effluent comprising a hydroprocessed fraction; and
feeding a second portion of the hydrogen stream, the first effluent, and the recovered medium boiling hydrocarbons to a second hydroprocessing unit to produce the petrochemical feedstock.

14. The process of claim 13, further comprising:
heating a wide boiling hydrocarbon mixture to a first temperature to produce a heated wide boiling hydrocarbon mixture;
separating a light boiling hydrocarbon fraction from the heated wide boiling hydrocarbon mixture to recover a light hydrocarbon fraction and the hydrocarbon mixture; and
feeding the hydrocarbon mixture to the stripping unit as the portion of the wide boiling hydrocarbon mixture.

15. The process of claim 13, wherein the hydrogen manufacturing unit produces a total amount of hydrogen required by the first hydroprocessing unit and the second hydroprocessing unit.

16. The process of claim 13, further comprising:
recycling a portion of the separated hydrogen manufacturing unit feedstock back to the stripping unit.

17. The process of claim 13, wherein the hydroprocessed fraction comprises middle boiling point hydrocarbons.

18. The process of claim 13, further comprising separating the light boiling hydrocarbons of the overhead stream from the middle boiling hydrocarbons of the overhead stream.

19. The process of claim 18, further comprising feeding the separated light boiling hydrocarbons to a steam cracking unit.

20. A system for processing a hydrocarbon mixture to produce a petrochemical feedstock, the system comprising:
a stripping unit configured for receiving a hydrogen manufacturing unit feedstock and a wide boiling hydrocarbon mixture and recovering a bottoms stream comprising heavier boiling hydrocarbons of the hydrocarbon mixture and an overhead stream comprising a mixture of the hydrogen manufacturing unit feedstock and light boiling hydrocarbons of the hydrocarbon mixture;
a separation unit in fluid communication with the stripping unit and configured for separating the hydrogen manufacturing unit feedstock stream from the light boiling hydrocarbons of the overhead stream;
a hydrogen manufacturing unit in fluid communication with the separation unit configured for producing a hydrogen stream from a first portion of the hydrogen manufacturing unit feedstock stream; and
a first hydroprocessing unit in fluid communication with the separation unit and configured to receive the bottoms stream and a portion of the hydrogen stream such that a petrochemical feedstock, a first effluent comprising middle boiling hydrocarbons, or both are produced.

21. The system of claim 20, further comprising a recycle line configured for recycling a second portion of the separated hydrogen manufacturing unit feedstock from the separation unit to the stripping unit.

22. The system of claim 20, further comprising a second hydroprocessing unit in fluid communication with the stripping unit and configured for receiving middle boiling hydrocarbons and producing the petrochemical feedstock.

23. The system of claim 22, further comprising a first effluent feed line configured for feeding the first effluent from the first hydroprocessing unit to the second hydroprocessing unit.

24. The system of claim 22, further comprising one or more hydrogen feed lines configured for feeding a portion of the hydrogen stream from the hydrogen manufacturing unit to the first hydroprocessing unit, the second hydroprocessing unit, or combinations thereof.
